(19) United States
(12) Patent Application Publication
(10) Pub. No.: US 2015/0233570 A1
(43) Pub. Date: Aug. 20, 2015

(54) ILLUMINATING DEVICE

(71) Applicant: Kabushiki Kaisha Toshiba, Minato-ku (JP)

(72) Inventors: Kakeru YAMAGUCHI, Yokohama-shi (JP); Michinobu Inoue, Yokohama-shi (JP); Kazuki Tateyama, Yokohama-shi (JP)

(73) Assignee: Kabushiki Kaisha Toshiba, Minato-ku (JP)

(21) Appl. No.: 14/605,312

(22) Filed: Jan. 26, 2015

(30) Foreign Application Priority Data
Feb. 18, 2014 (JP) 2014-029005

(51) Int. Cl. F21V 29/78; F21V 29/83; F21V 29/74

(52) U.S. Cl. CPC F21V 29/78; F21V 29/745; F21V 29/83; F21Y 2101/02

(57) ABSTRACT

According to one embodiment, an illuminating device having a base plate, a heat sink and a light emitting unit. The heat sink includes cylindrical fins and a flat fin. The cylindrical fins are provided on a primary plane of the base plate vertically to the primary plane and are disposed concentrically. The flat fin is provided on the base plate vertically to the primary plane and extends from a center axis of concentric circles of the cylindrical fins to an outer rim of the cylindrical fins. The light emitting unit is provided on a plane opposite to the plane of the base plate on which the cylindrical fins are provided.

### CROSS-REFERENCE TO RELATED APPLICATION

This application is based upon and claims the benefit of priority from the prior Japanese Patent Application No. 2014-029005, filed on Feb. 18, 2014, the entire contents of which are incorporated herein by reference.

### FIELD

Embodiments described herein relate generally to an illuminating device.

### BACKGROUND

In light emitting diodes (LED) housed in an illuminating device, electric energy is converted into heat energy when an electric current flows so that heat is generated to raise the temperature of the light emitting diodes. When a light emitting diode enters a high temperature state, light emission brightness and life of the light emitting diode lower in some cases. An illuminating device in which a heatsink made of a highly heat conductive material such as metal is disposed to radiate heat produced from light emitting diodes is known.

On the other hand, since an illuminating device of a downlight-type, for example, is attached to a ceiling, the illuminating device is preferably light. However, a metal heatsink needs to be mounted for the above reason, and thus it is difficult to reduce the weight of the illuminating device.

### BRIEF DESCRIPTION OF THE DRAWINGS

FIG. 1A illustrates a longitudinal cross-sectional view of an illuminating device according to an embodiment.

FIG. 1B is a perspective view of the illuminating device according to the embodiment.

FIG. 1C is a cross-sectional view in case where the illuminating device according to the embodiment is cut at a portion different from that shown in FIG. 1A.

FIG. 1D is a horizontal cross-sectional view in case where the illuminating device according to the embodiment is cut in a direction vertical to the cross section shown in FIG. 1A.

FIG. 2A is a perspective view illustrating an illuminating device according to a modified example of the embodiment.

FIG. 2B is a cross-sectional view in case where the illuminating device according to the modified example is cut at a portion different from that shown in FIG. 2A.

FIG. 2C is a cross-sectional view in case where the illuminating device according to the modified example is cut in a direction vertical to the cross section in FIG. 2A.

FIG. 2FD is a horizontal cross-sectional view in case where the illuminating device according to the modified example is cut in a direction vertical to the cross section shown in FIG. 2A.

FIG. 3 is a view illustrating air currents in the illuminating device according to the embodiment.

FIG. 4 illustrates a horizontal cross-sectional view of an illuminating device according to another exemplary embodiment.

FIG. 5 illustrates a horizontal cross-sectional of an illuminating device view according to another exemplary embodiment.

FIG. 6 illustrates a horizontal cross-sectional of an illuminating device view according to another exemplary embodiment.

FIG. 7 illustrates a horizontal cross-sectional of an illuminating device view according to another exemplary embodiment.

FIG. 8 illustrates a horizontal cross-sectional of an illuminating device view according to another exemplary embodiment.

FIG. 9 illustrates a horizontal cross-sectional of an illuminating device view according to another exemplary embodiment.

FIG. 10 illustrates a cross-sectional view of an illuminating device according to another exemplary embodiment.

FIG. 11 illustrates a cross-sectional view of an inflow of air through an illuminating device according to another exemplary embodiment.

FIG. 12 is a view illustrating cylindrical fins and flat fins of the illuminating device according to the embodiment.

FIG. 13 is a view illustrating a base plate of the illuminating device according to the embodiment.

FIG. 14 is a view illustrating a heatsink of an illuminating device according to a comparative example.

### DETAILED DESCRIPTION

According to one embodiment, an illuminating device having a base plate, a heat sink and a light emitting unit. The heat sink includes cylindrical fins and a flat fin. The cylindrical fins are provided on a primary plane of the base plate vertically to the primary plane and are disposed concentrically. The flat fin is provided on the base plate vertically to the primary plane and extends from a center axis of concentric circles of the cylindrical fins to an outer rim of the cylindrical fins. The light emitting unit is provided on a plane opposite to the plane of the base plate on which the cylindrical fins are provided.

Hereinafter, a further embodiment will be described with reference to the drawings. In the drawings, the same reference numerals denote the same or similar portions respectively.

The drawings are schematic or conceptual. A relationship between a thickness and a width of each component, and a ratio of sizes of components are not necessarily the same as those in reality. Further, even if the same components are illustrated, the components may be shown with different dimensions and ratios depending on the drawings.

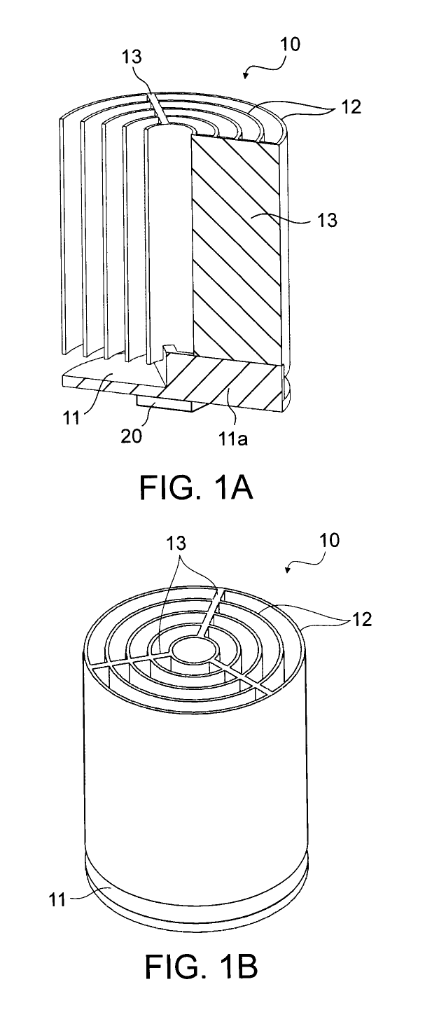

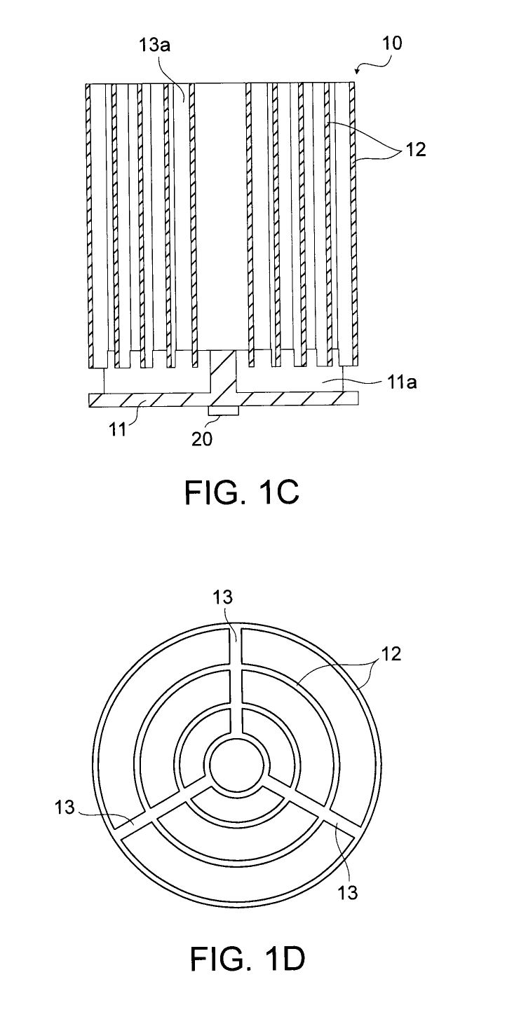

FIGS. 1A to 1D illustrate an illuminating device according to a first embodiment. FIG. 1A is a longitudinal cross-sectional view and FIG. 1B is a perspective view. FIG. 1C is a vertical cross-sectional view in case where the illuminating device according to the embodiment is cut at a portion different from that shown in FIG. 1A. FIG. 1D is a horizontal cross-sectional view in case where the illuminating device according to the embodiment is cut in a direction vertical to the cross-section shown in FIG. 1A.

As illustrated in FIGS. 1A to 1D, the illuminating device according to the present embodiment has a heatsink 10 and a light emitting unit 20. The heatsink 10 has a circular base plate 11, cylindrical fins 12 and flat fins 13. The base plate 11 has a projection 11a which extends in a radial pattern in a primary plane direction, i.e., along three directions, and can be formed by die molding or cutting using a highly heat conductive material such as aluminum diecast alloy.

The cylindrical fins 12 are provided such that an axial direction of the cylindrical fins 12 is vertical to a primary plane of the base plate 11. The cylindrical fins 12 have the same center axis, and are concentrically disposed.

Similarly to the cylindrical fins 12, the flat fins 13 are provided vertically to the primary plane of the base plate 11. Each of the flat fins 13 is, for example, a plate member which extends radially from the center axis of the cylindrical fins 12 along a direction traveling to an outer rim portion of the cylindrical fins 12. The flat fins 13 are provided to connect between the cylindrical fins 12. As illustrated in FIGS. 1A to 1D, each of the flat fins 13 may connect all of the cylindrical fins 12 or connect some cylindrical fins 12 of the cylindrical fins 12.

The cylindrical fins 12 and the flat fins 13 can be extruded using a highly heat conductive material such as aluminum alloy, for example.

The light emitting unit 20 is provided on a plane opposite to the plane of the base plate 11 on which the cylindrical fins 12 are provided. The light emitting unit 20 is formed by a light emitting diode (LED) formed on an insulating substrate, for example.

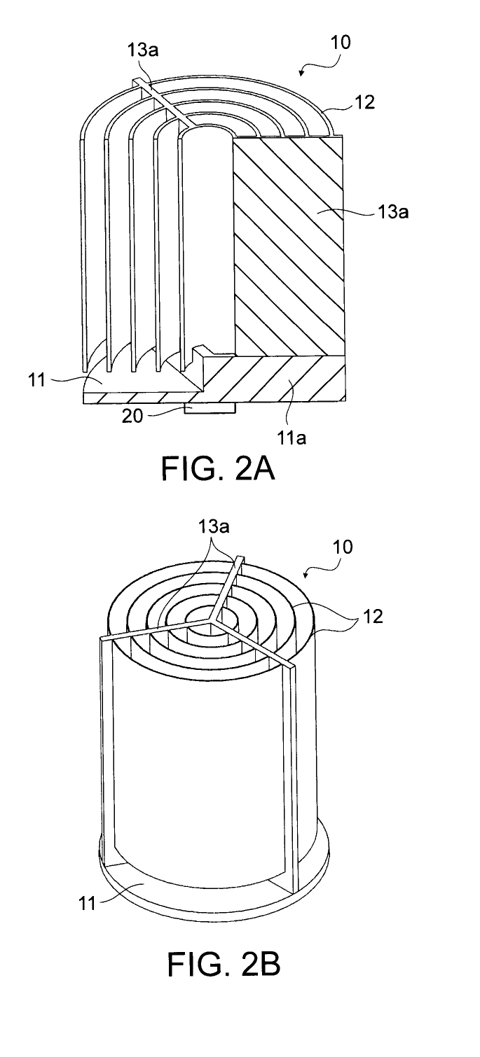

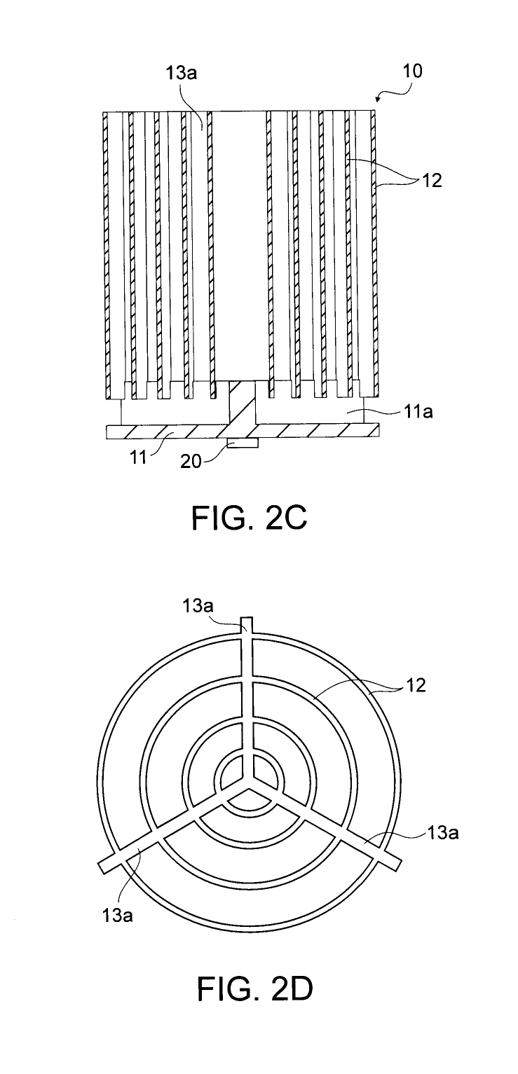

FIGS. 2A to 2D illustrate an illuminating device according to a modified example of the embodiment. FIG. 2A is a longitudinal cross-sectional view, FIG. 2B is a perspective view, FIG. 2C is a vertical cross-sectional view cut at a portion different from that illustrated in FIG. 2A, and FIG. 2D is a horizontal cross-sectional view.

As illustrated in FIGS. 2A to 2D, in the illuminating device according to the modified example, flat fins 13a are respectively provided to pierce cylindrical fins 12 in a radial direction. In this case, each of the flat fins 13a may pierce toward an inner side of the cylindrical fin 12 closest to a center axis of concentric cylinders formed by the cylindrical fins 12, or toward an outer side of the cylindrical fin 12 positioned at an outermost side.

The above illuminating devices according to the first embodiment and the modified example can efficiently radiate heat based on a chimney effect of the cylindrical fins 12 disposed concentrically.

Each of the flat fins 13a connects the cylindrical fins 12 so that it is possible to transfer heat between the cylindrical fins 12 and to radiate heat from all of the cylindrical fins 12 efficiently. A large amount of heat is considered to be transferred collectively to the cylindrical fins 12 near a light emitting unit 20. However, the heat is transferred to the other cylindrical fins 12 through the flat fins 13a and is dispersed so that it is possible to enhance a heat radiation effect.

A gap is provided between at least part of end portions of the cylindrical fins 12 and a primary plane of a base plate 11, desirably. As illustrated in FIGS. 1A to 1C, for example, the illuminating device according to the embodiment is provided with a projection 11a on the base plate 11 so that it is possible to provide the gap by locating the cylindrical fins 12 on the projection 11a. Such a configuration can effectively produce a chimney effect based on natural convection.

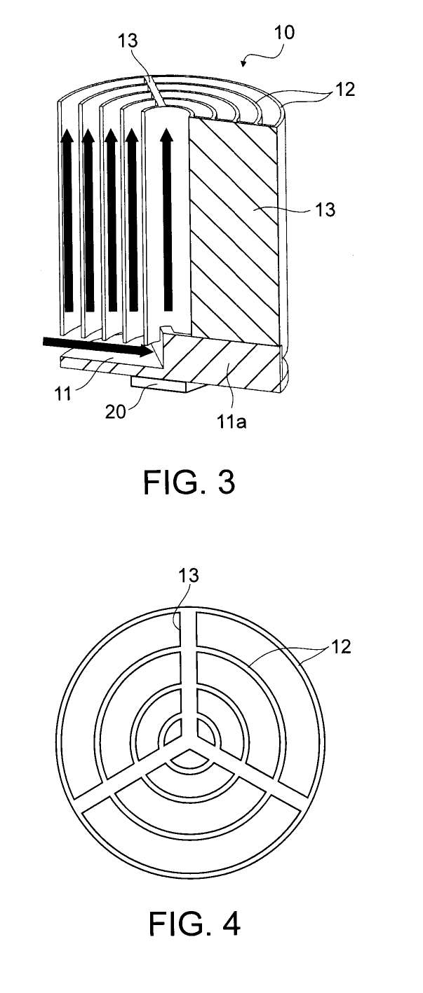

FIG. 3 illustrates air currents in the illuminating device according to the first embodiment. As illustrated in FIG. 3, the atmospheric air around the cylindrical fins 12 flows between the cylindrical fins 12 and the base plate 11, removes heat transferred from the light emitting unit 20 to the base plate 11, and passes through the inside of the cylindrical fins 12. As a result, it is possible to provide a higher heat radiation effect.

The center axis of the cylindrical fins 12 which are disposed concentrically matches the center of the light emitting unit 20 desirably. Such an arrangement makes it possible to disperse heat produced by the light emitting unit 20 to the cylindrical fins 12 effectively and to enhance the heat radiation effect.

The cylindrical fins 12 have a rotational symmetrical shape with respect to the center axis of the concentric circles desirably. The cross-sectional shapes of the cylindrical fins 12 are, for example, a polygonal shape such as a square shape and a hexagonal shape, or a circular shape such as an elliptical shape and a circular shape. Most desirably, the cross-sectional shapes of the cylindrical fins 12 are circular. When the cross-sectional shapes of the cylindrical fins 12 are circular and the center axis of the cylindrical fins 12 disposed concentrically coincides with a center of a light emitting unit 20, the distances from the center of the light emitting unit 20 to respective portions of each cylindrical fin 12 are equal and the temperature distributions caused by heat produced from the light emitting unit 20 become substantially equal. These temperature distributions make it possible to radiate heat uniformly through the cylindrical fins 12. As a result, it is possible to prevent a phenomenon that heat concentrates on a specific portion and the temperature becomes high, for example.

Further, any of the cylindrical fins 12 have the same cross-sectional shape and different sizes, desirably. Such a configuration makes it possible to disperse heat uniformly and to radiate heat effectively.

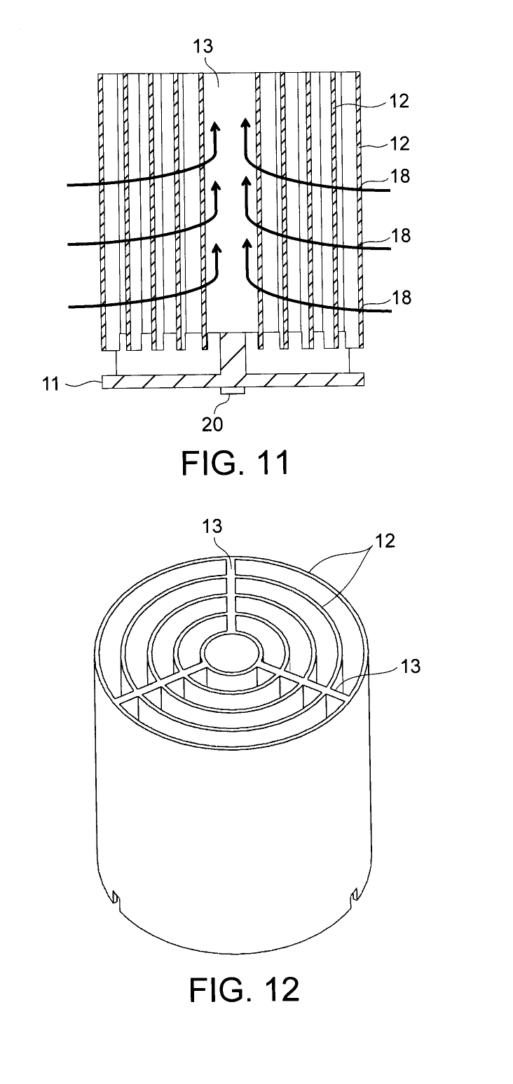

FIGS. 4 to 11 illustrate other examples of the illuminating device according to the embodiment. FIGS. 4 to 9 are longitudinal cross-sectional views, and FIGS. 10 and 11 are horizontal cross-sectional views.

As illustrated in FIG. 4, the thicknesses of the flat fins 13 can be made thicker than those of the cylindrical fins 12. Setting such thicknesses make it possible to transfer heat effectively between the cylindrical fins 12. Consequently, heat does not concentrate on specific one of the cylindrical fins 12 and can be dispersed to all of the cylindrical fins 12. As a result, it is possible to radiate heat efficiently from any of the cylindrical fins 12.

Particularly when the light emitting unit 20 is disposed such that the center axis of the cylindrical fins 12 disposed concentrically coincides with the center of the light emitting unit 20, it is possible to radiate heat from all of the cylindrical fins 12 efficiently.

In this case, it is assumed that heat is transferred from the light emitting unit 20 to one of the cylindrical fins 12 more, as the one of the cylindrical fins 12 is closer to an inside. However, by increasing the thicknesses of the flat fins 13 as illustrated in FIG. 4, it is also possible to transfer heat to ones of the cylindrical fins 12 arranged on an outer side effectively, and to use all cylindrical fins 12 for heat radiation effectively.

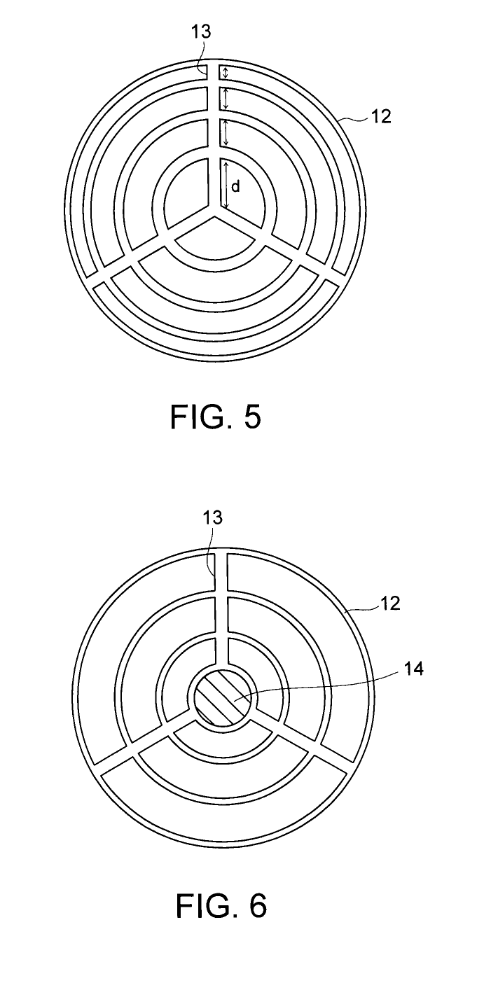

As illustrated in FIG. 5, the interval d between neighboring ones of the cylindrical fins 12 can be made wider, as the neighboring ones are closer to the center axis of the cylindrical fins 12 disposed concentrically. Such a setting makes air current flow more easily through the interval between the neighboring ones of the cylindrical fins 12 disposed concentrically as the neighboring ones are closer to the inside so that the heat radiation effect is enhanced.

Particularly when the light emitting unit 20 is disposed such that the center axis of the cylindrical fins 12 coincides with the center of the light emitting unit 20, it is possible to enhance the heat radiation effect. In this case, it is likely that heat concentrates more and the temperature becomes higher in an inside of one of the cylindrical fins 12 as it is closer to the center axis. Thus, by locating the neighboring ones of the cylindrical fins 12 with wider intervals, it is possible to encourage heat radiation. Further, only the interval around one of the cylindrical fins 12 at which heat is easy to concentrate at the most may be made wide, instead of making the interval d between the neighboring ones of the cylindrical fins 12 wider as the neighboring ones are closer to the center axis of the cylindrical fins 12.

As illustrated in FIG. 6, a columnar heat conducting member 14 may be inserted in an innermost cylindrical fin 12. For example, copper can be used for the heat conducting member 14. Instead of the heat conducting member 14, a heat transport part such as a heat pipe may be inserted. The heat conducting member 14 can efficiently transfer heat transferred from the light emitting unit 20 to the base plate 11, further to upper end portions of the cylindrical fins 12. Such a configuration can enhance heat radiation performance.

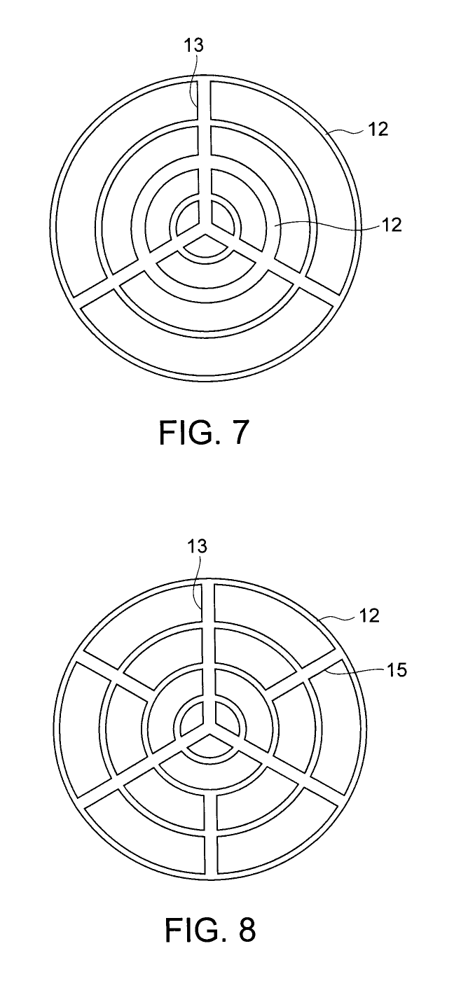

As illustrated in FIG. 7, part of the cylindrical fins 12 can be made thicker than the other cylindrical fins 12. In this case, the thickness of one of the cylindrical fin 12 near the light emitting unit 20 as a heat source may be increased. This setting can efficiently transfer heat transferred from the light emitting unit 20 to the base plate 11, further to the cylindrical fins 12, and enhance the heat radiation effect. Particularly, when the light emitting unit 20 is disposed such that the center axis of the cylindrical fins 12 coincides with the center of the light emitting unit 20, it is possible to effectively radiate heat by making the thicknesses of the cylindrical fins 12 positioned inside a concentric circle thicker than those of the cylindrical fins 12 positioned outside the concentric circle.

As illustrated in FIG. 8, local flat fins 15 which connect some of the cylindrical fins 12 may be further provided. Each of the local flat fins 15 is desirably provided to connect some cylindrical fins 12 in particular on which heat is considered to concentrate. The local flat fins 15 can disperse heat more to the cylindrical fins 12 which are apart from each other, and enhance heat radiation performance. Particularly, by avoiding locating a local flat fin around the center of the cylindrical fins 12, it is possible to enhance heat radiation performance while securing a good aeration property in a center portion. In the example shown in FIG. 8, the local flat fins 15 are provided to connect some cylindrical fins 12 positioned outside a concentric circle. Locations at which the local flat fins 15 are provided are not limited to the above. For example, the local flat fins 15 may be provided to connect some cylindrical fins 12 positioned inside or in the middle of the concentric circle. In these cases, one local flat fin 15 may be provided.

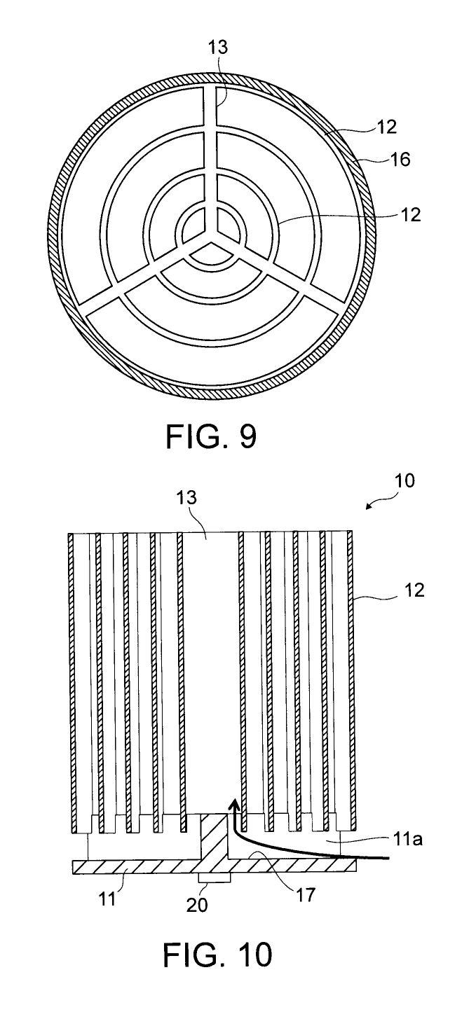

As illustrated in FIG. 9, a coating 16 of good heat radiation performance can be formed by applying paint to one of the cylindrical fins 12 positioned on the outermost side. By forming the coating 16, it is possible to increase a heat radiation amount of radiation.

As illustrated in FIG. 10, an inclined portion 17 may be provided. The inclined portion 17 is provided at a connection portion between the base plate 11 and the projection 11a. The cross-sectional shape of the base plate 11 is a shape which is inclined toward the center axis of the cylindrical fins 12. The inclined portion 17 can guide air to the inside of the pipe of one of the cylindrical fins 12 close to the center axis easily, increase a flow rate of the air, and enhance heat radiation performance.

Particularly, when the light emitting unit 20 is disposed such that the center axis of the cylindrical fins 12 coincides with the center of the light emitting unit 20, it is possible to increase a flow rate of air around the light emitting unit 20 as the heat source effectively.

As illustrated in FIG. 11, holes 18 may be provided in the cylindrical fins 12, respectively. The holes 18 enable an inflow of air from side surfaces of the cylindrical fins 12 so that it is possible to cool the cylindrical fins 12 effectively. One hole may be provided to each of the cylindrical fins 12. However, by providing a plurality of holes, it is possible to cool the cylindrical fins 12 more effectively. Further, it is possible to reduce the amount of metal of the cylindrical fins 12 and reduce the weight of the cylindrical fins 12 by making the holes 18.

An example of a method of manufacturing the illuminating device according to the embodiment will be described below.

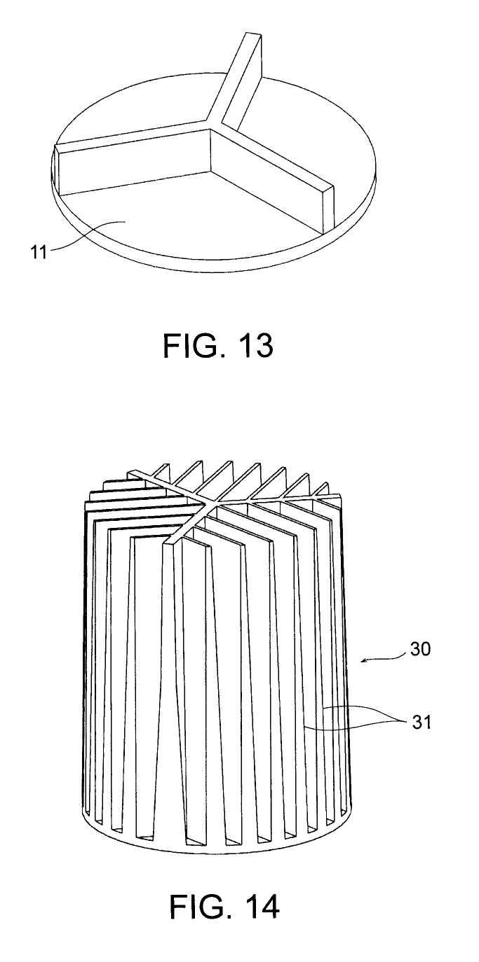

As illustrated in FIG. 12, cylindrical fins 12 and flat fins 13 are integrally formed by extrusion, for example. As illustrated in FIG. 13, a base plate 11 is formed by die forming or cutting, for example. In this way, two parts including a part of the integrated cylindrical fins 12 and flat fins 13 and the base plate 11 are prepared. A heatsink 10 illustrated in FIGS. 1A to 1C is formed by assembling these two parts by screwing, soldering or brazing. This manufacturing method includes a smaller number of steps and can make manufacturing relatively simple. Further, the manufacturing method does not require a complex process operation and realize high productivity at low cost.

Comparison between characteristics of the above illuminating device according to the embodiment and an illuminating device according to a comparative example will be described. FIG. 14 illustrates a heatsink 30 of the illuminating device according to the comparative example formed by die forming. Characteristics such as heat transfer coefficients of the heatsink 10 of the illuminating device according to the embodiment of FIGS. 1A to 1C and the heatsink 30 of the illuminating device according to the comparative example of FIG. 14 were estimated. In both cases, a light emitting unit 20 were disposed at each center of the heatsinks 10, 30. Table 1 shows characteristics such as heat transfer coefficients of the heatsink 10 according to the embodiment and the heatsink 30 according to the comparative example.

TABLE 1

| | | | | Heat Transfer |
|---|---|---|---|---|
| | Heat | | | Coefficient |
| | Transfer | | | per Unit |
| | Coefficient | | Surface | Weight |
| | (W/m²/° C.) | Weight (Kg) | Area (m²) | (W/m²/° C. · Kg) |
| Comparative | 3.11 | 2.03 | 0.31 | 1.53 |
| Example | | | | |
| Embodiment | 2.37 | 1.13 | 0.36 | 2.08 |

Table 1 shows that the heatsink 10 according to the embodiment is lighter than the heatsink 30 according to the comparative example. Table 1 further shows that the heatsink 10 according to the embodiment realizes higher heat radiation performance that of the heatsink 30 according to the comparative example.

The heatsink 30 according to the comparative example requires a “draft angle” for die cutting in heat radiation fins 31 upon die forming. Thus, as portions of the heat radiation fins 31 are closer to the base plate disposed below the heatsink 30, gaps between the portions of the heat radiation fins 31 become smaller, which make air currents difficult to pass through the gaps. In contrast, the heatsink 10 according to the embodiment has a ventilation path between the cylindrical fins 12 and the base plate 11 to allow air pass. As a result, it is possible to cool the vicinity of the light emitting unit 20 as a heat source, effectively. Further, by concentrically disposing the cylindrical fins 12 of the cylindrical shapes, it is possible to accelerate the flow rate of air currents between the cylindrical fins 12 based on a chimney effect.

The cylindrical fins 12 are integrally shaped by extrusion so that a “draft angle” is not required unlike heat radiation fins formed by die forming, and heat radiation fins having uniform thicknesses can be formed. As a result, it is possible to reduce the amount of metal of the cylindrical fins 12 and reduce the weight of the cylindrical fins 12. Generally, thicker members which form a heatsink can transfer more heat to end portions of the heatsink. However, an aluminum extrusion member having better heat conductivity than that of aluminum diecast alloy is used for the heatsink 10 according to the embodiment. Consequently, even when fins which form the heatsink 10 have thin shapes like the cylindrical fins 12, it is possible to transfer heat to the end portions of the cylindrical fins 12. The above-described various contrivances allow the illuminating device according to the embodiment to secure a wide surface area and realize high heat radiation performance even though the amount of metal is less.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. An illuminating device comprising:
a base plate;
a heat sink having cylindrical fins and a flat fin, the cylindrical fins being provided on a primary plane of the base plate vertically to the primary plane and being disposed concentrically, the flat fin being provided on the base plate vertically to the primary plane and extending from a center axis of concentric circles of the cylindrical fins to an outer rim of the cylindrical fins; and
a light emitting unit provided on a plane opposite to the plane of the base plate on which the cylindrical fins are provided.

2. The illuminating device according to claim 1, wherein a gap is provided between at least part of end portions of the cylindrical fins and the primary plane of the base plate.

3. The illuminating device according to claim 1, wherein the light emitting unit is positioned on the center axis of the cylindrical fins.

4. The illuminating device according to claim 1, wherein the cylindrical fins has a rotational symmetrical shape with respect to the center axis.

5. The illuminating device according to claim 1, wherein a cross-sectional shape of the cylindrical fins is circular.

6. The illuminating device according to claim 1, wherein the flat fin is thicker than the cylindrical fins.

7. The illuminating device according to claim 1, wherein an interval between neighboring ones of the cylindrical fins is wider as the neighboring ones are closer to the center axis.

8. The illuminating device according to claim 1, wherein a heat conducting member is inserted inside an innermost one of the cylindrical fins.

9. The illuminating device according to claim 1, wherein thicknesses of the cylindrical fins positioned inside are thicker than the cylindrical fins positioned outside.

10. The illuminating device according to claim 1, further comprising a local flat fin which connects some of the cylindrical fins.

11. The illuminating device according to claim 1, wherein paint is applied to an outermost one of the cylindrical fins to form a coating film.

12. The illuminating device according to claim 1, wherein a cross-sectional shape of the base plate is inclined toward the center axis.

13. The illuminating device according to claim 1, wherein the cylindrical fins include holes.

14. The illuminating device according to claim 1, further comprising flat fins including the flat fin,
wherein the flat fins are provided on the base plate vertically to the primary plane and extend from the center axis of the concentric circles of the cylindrical fins radially to the outer rim of the cylindrical fins.

15. The illuminating device according to claim 2, wherein the light emitting unit is positioned on the center axis of the cylindrical fins.
